(19) United States
(12) Patent Application Publication
(10) Pub. No.: US 2022/0148014 A1
(43) Pub. Date: May 12, 2022

(54) METHODS AND SYSTEMS FOR GENERATING NOTIFICATIONS FROM A COMPUTING SYSTEM

(71) Applicant: Shopify Inc., Ottawa (CA)

(72) Inventors: John Jong Suk LEE, Waterloo (CA); Jacinthe RICARD, Montreal (CA)

(73) Assignee: Shopify Inc., Ottawa (CA)

(21) Appl. No.: 17/095,039

(22) Filed: Nov. 11, 2020

(51) Int. Cl. G06Q 30/02; G06Q 10/06; H04L 12/58

(52) U.S. Cl. CPC G06Q 30/0201; H04L 51/24; G06Q 30/0277; G06Q 10/06313

(57) ABSTRACT

Methods and systems for generating notifications to users. The methods may include selecting, based on a first characteristic and the stored data associated with each user, a first subset of users from the set of users and transmit a primary notification to the first subset of users. The system detects whether the users perform a particular user action and segments the first subset into a first group of users associated with the particular user action and a second group of users not associated with the particular user action. The system identifies a second characteristic different from the first characteristic and correlated to the second group of users. It then identifies a third group of users having the second characteristic and generates a secondary notification for transmission to the third group of users.

### FIELD

The present disclosure relates to generating notifications from a computer system.

### BACKGROUND

In a number of contexts, a computing system with a large set of users may generate or transmit notifications intended to elicit a user action. In some cases, the computing system notification may be part of a “campaign”. A campaign may include a variety of notifications targeting one or more users, potentially to similar ends.

### BRIEF DESCRIPTION OF THE DRAWINGS

Embodiments will be described, by way of example only, with reference to the accompanying figures wherein:

FIG. 1 is a block diagram of an example e-commerce platform, according to one embodiment;

FIG. 2 is an example of a home page of an administrator, according to one embodiment;

FIG. 3 shows, in block diagram form, one example of an e-commerce platform for generating notifications;

FIG. 4 shows, in flowchart form, one example method of generating notifications from a computer system;

FIG. 5 shows, in flowchart form, another example method of generating notifications from a computer system;

FIG. 6 shows, in flowchart form, a further example method of generating notifications from a computer system; and

FIG. 7 shows, in flowchart form, yet a further example method of generating notifications from a computer system.

### DETAILED DESCRIPTION

In one aspect, the present application describes a method for generating notifications from a computing system. The method may include selecting, based on a first characteristic and stored data associated with each user, a first subset of users from a set of users; transmitting a primary notification to the first subset of users; detecting whether the primary notification produced a particular user action for the users of the first subset of users and segmenting the first subset into a first group of users associated with the particular user action and a second group of users not associated with the particular user action; identifying, using the stored data associated with each user in the second group of users not associated with the particular user action, a second characteristic different from the first characteristic and correlated to the second group of users; identifying a third group of users having the second characteristic; and generating a secondary notification for transmission to the third group of users.

In some implementations, the secondary notification generated may be an alternative notification different from the primary notification.

In some implementations, the method may include subsequently adding a new user to the set of users, the new user having the second characteristic, and transmitting the secondary notification to the new user instead of the primary notification when transmitting the primary notification to a further subset of the set of users.

In some implementations, the method may include subsequently selecting a second subset of users from a then-current set of users based on the first characteristic; identifying a subgroup of users in the second subset that have the second characteristic; transmitting a second primary notification to the second subset of users excluding the subgroup of users; and transmitting the secondary notification to the subgroup of users.

In some implementations, the method may further include generating two or more notifications based on the second characteristic, sending data regarding the two or more notifications to a merchant account, receiving a selection response indicating one of the two or more notifications, and transmitting the selected notification as the secondary notification to the third group of users.

In some implementations, identifying may include determining that the second characteristic is uncorrelated with the first group of users. In some cases, identifying includes calculating a correlation coefficient.

In some implementations, wherein the secondary notification has at least one of different content from the primary notification or a different communication channel from the primary notification.

In some implementations, the computing system includes an ecommerce platform and the data regarding each user includes at least product purchase data relating to a merchant, and wherein the primary notification and the secondary notification each contain product information regarding one or more products available from the merchant. In some cases, the second characteristic relates to product purchase history with respect to the merchant. In some such cases, the second characteristic is one of time of last product purchase, last product purchased, number of products purchased, frequency of discounted products purchased, or frequency of new products purchased.

In another aspect, the present application describes a computer system to generate notifications that includes one or more processors, memory storing data associated with each user in a set of users, and a processor-readable storage medium containing processor-executable instruction that, when executed by the one or more processors, are to cause the one or more processors to carry out the operations of one or more of the methods described herein.

In yet a further aspect, the present application describes a non-transitory computer-readable medium storing processor-executable instructions for generating notifications from a computing system, wherein the instructions, when executed by one or more processors, are to cause the one or more processors to carry out the operations of one or more methods described herein.

For illustrative purposes, specific example embodiments will now be explained in greater detail below in conjunction with the figures.

In a number of contexts, a computing system with a large set of users may generate or transmit notifications intended to elicit a user action. For example, the user action may be accepting an invitation, clicking a link, permitting a download, changing a setting, sending a reply message, etc. In some cases, the computing system notification may be part of a “campaign”, where the campaign may be a marketing campaign, election campaign, donation campaign, feedback campaign, or other such user outreach. In a campaign of this nature, the notifications are intended to prompt a particular user action. In the case of a marketing campaign, examples of the user action may include selection of a link, visitation of an online store, purchase of a particular product, etc.

Campaigns may be conducted serially, where a first campaign targets a notification to a group of users/recipients based on some characteristic of the group, e.g., geographical location, demographic characteristics, purchase history, etc. A user's response or non-response to the first campaign notification may be used by the computer system to refine the user data associated with that user in order to micro-target that user in a future campaign, e.g. by including/excluding the user from a second campaign notification or modifying the specific notification sent to that user.

This user-specific refinement of user data characteristics may be used by the computer system to micro-target a specific user with notifications tailored to that specific user in order to try to better elicit a desired user action. In some cases, each user may be sent a first notification and the response or non-response is used to refine the next notification, the response to which is used to further refine the next notification and so on, so as to build a user-specific profile upon which to base future notifications to that user.

It would be advantageous to reduce the number of notifications while still eliciting desired user actions.

In accordance with one aspect, the present application provides systems and methods of user notification that segment users, including future users, by identifying a characteristic correlated to users not taking a particular user action. The particular user action may be defined as an action in connection with a first or primary notification sent by the system to a set of users. The computer system may detect whether the particular user action is taken or performed by each of the users in the set of users. The computer system may then identify a characteristic correlated to the group of users for which the particular user action was not detected. On that basis, the computer system may identify that users having that characteristic are non-response to the first or primary notification and, in the future, when sending the first or primary notification it may exclude the users having that characteristic.

In some cases, the computer system may identify a new notification for sending to users having the characteristic. That is the set of users, or an updated set of users, may be segmented using the identified characteristic to group those users having the characteristic and sending them the new notification instead of the primary notification. The group of users may include users who previously received the primary notification and may include users that did not receive the primary notification.

In some cases, the particular user action may be defined as an action in connection with some other event or occurrence not triggered by a notification sent by the system to a set of users. For example, the particular user action may be accessing an online portal within a time window following an event, such as a concert or sporting event.

In some cases, the set of users is a set identified by segmenting a larger primary set of users on the basis of one or more user characteristics. Those characteristics may be any one or more characteristics that may be used to segment the primary set of users, e.g., geographical location, demographic characteristics, purchase history, etc.

As noted, the notifications may be in connection with a campaign, such as a marketing campaign, political campaign, charitable campaign, etc. Because some of the examples described herein may, in some cases, relate to online commerce marketing campaigns, e.g. from merchants to consumers, in some cases the computer system may include an e-commerce platform. The e-commerce platform may be specific to a particular merchant or may host a plurality of merchants.

Example e-Commerce Platform

In some embodiments, the methods disclosed herein may be performed on or in association with an e-commerce platform. Therefore, an example of an e-commerce platform will be described.

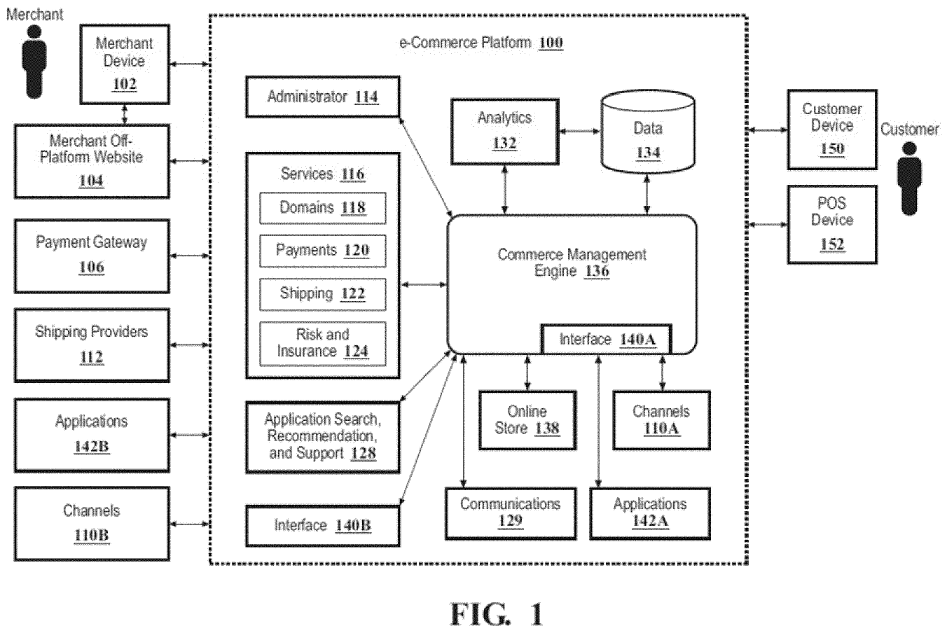

FIG. 1 illustrates an e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers (or “purchasers”) as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics via an analytics component 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In some embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In some embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

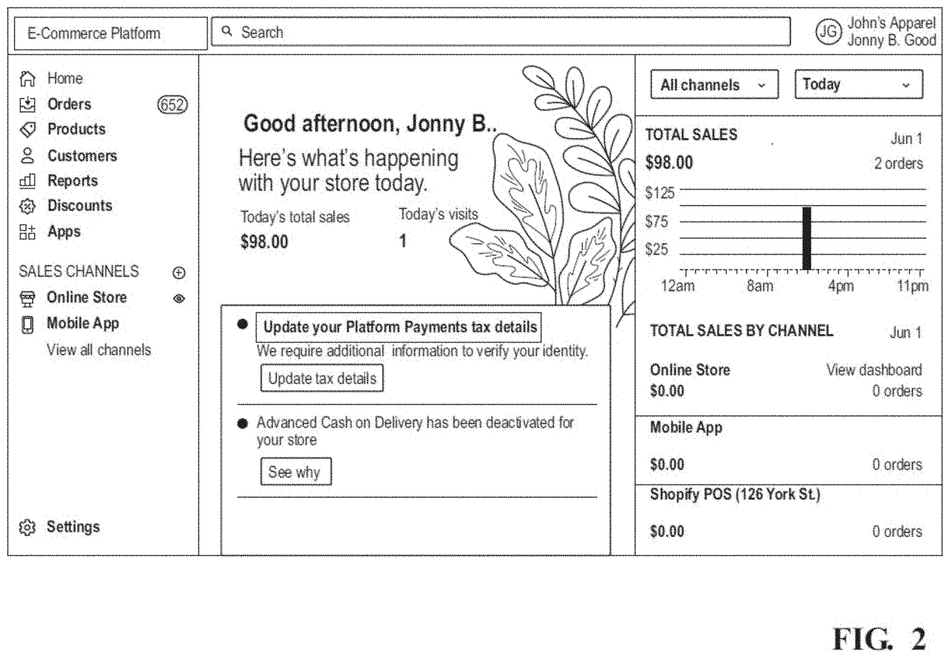

FIG. 2 depicts a non-limiting embodiment for a home page of an administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for the communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a platform payment facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's bank account (e.g., when using capital), and the like. These systems may have Sarbanes-Oxley Act (SOX) compliance and a high level of diligence required in their development and operation. The platform payment facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics, for example using the analytics component 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In some embodiments, an application 142A may be provided by the same party providing the platform 100 or by a different party. In some embodiments, an application 142B may be provided by the same party providing the platform 100 or by a different party. The commerce management engine 136 may be configured for flexibility and scalability through portioning (e.g., sharing) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for the platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through an application search, recommendations, and support platform 128 or system. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide the application search, recommendation and support platform 128. The application search, recommendation and support platform 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the lifespan of a cart may be in the order of minutes, carts may be persisted to an ephemeral data store in some cases. However, in many implementations, while the customer session may only last minutes, the merchant and/or customer may wish to have the possibility of returning to a cart built in a previous session. Accordingly, the cart, e.g. the shopping cart data structure populated with product item data and a user identifier, may be stored in persistent memory on the platform 100.

In a typical session, a customer proceeds to checkout at some point after adding one or more items to their shopping cart. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer does not complete the transaction, the e-commerce platform 100 may retain the shopping cart data structure in memory so that the customer may return to the partially-completed cart in a subsequent session (e.g., in an abandoned cart feature).

Checkouts may calculate taxes and shipping costs based on the customer's shipping address. Checkout may delegate the calculation of taxes to a tax component and the calculation of shipping costs to a delivery component. A pricing component may enable merchants to create discount codes. Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Automatically Generating Notifications

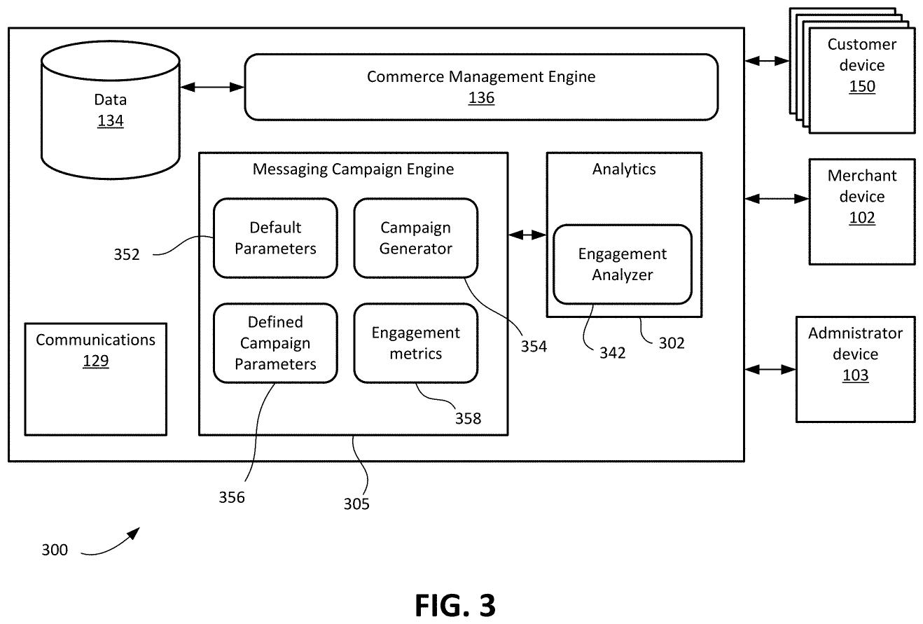

FIG. 3 shows, in block diagram form, one example of a system for handling queued requests. In this example, the system is an e-commerce platform 300. The e-commerce platform 300 may include the commerce management engine 136, the analytics component 132, the data repository 134, and various other components (not shown) described in connection with the e-commerce platform 300 depicted in FIG. 1. In particular, FIG. 3 illustrates some details of the e-commerce platform 300 that may be used in generating and managing a messaging campaign.

It will be appreciated that although FIG. 3 illustrates an example in the context of an e-commerce system, it is illustrative and not restrictive. In some cases, the present application describes systems and methods that may be used by an e-commerce platform but may be implemented outside of the platform. In some cases, those methods or systems may provide a service to the e-commerce platform. In some implementations, the present application may be implemented for use in connection with systems other than e-commerce platforms. For example, the present application may be applicable in the context of online advertising, social media, or other such computer-implemented systems.

In the context of a messaging campaign, a customer of the e-commerce platform 300 may also be termed a user and/or recipient of a directed messaging campaign. The customer as a user/recipient may interact with the e-commerce platform 300 via the customer device 150. However, it will be appreciated that not all customers of the e-commerce platform 300 may be a recipient of a messaging campaign, and not all recipients of a messaging campaign may be a customer of the e-commerce platform 300. For generality, the present disclosure may refer interchangeably to “users” or “recipients” of a directed messaging campaign. In cases where a recipient is not a current customer of the e-commerce platform 300, the e-commerce platform 300 may nonetheless obtain at least generalized information about the online behavior of the non-customer recipient, for example via anonymized statistical data and/or via user-consented sharing of information with a social media platform, among other possibilities. That data may be stored in the data repository 134 or elsewhere.

In the context of a messaging campaign, a merchant on the e-commerce platform 300 may also be a marketer engaged in a messaging campaign. The merchant/marketer may interact with the e-commerce platform 300 via the merchant device 102. Additionally, a marketer or administrator or other third party (who is not also a merchant on the e-commerce platform 300) may interact with the e-commerce platform 300 via an administrator device 103. Such a marketer may, for example, use certain services provided by the e-commerce platform 300, such as for generating a messaging campaign as discussed below, without having to be a customer or merchant who is subscribed to the e-commerce platform 300. In some examples, the e-commerce platform 300 may make certain services/applications, such as the messaging campaign engine discussed below, accessible to users as standalone services/applications.

The analytics component 132 in this example includes an engagement analyzer 342, which may be implemented as a sub-module of the analytics component 132 or may be implemented as part of the general functions of the analytics component 132. As will be discussed further below, the engagement analyzer 342 serves to analyze online behavior of customers, in order to determine (a level of) engagement of customers with certain distribution channels, certain online stores and/or certain messages, among other possibilities. In some examples, some or all functions of the engagement analyzer 342 may be implemented using a machine-learning system. In general, the engagement component 342, on its own or together with external third party services, may detect whether a customer or user has taken a particular user action.

The e-commerce platform 300 in this example includes a messaging campaign engine 350. The messaging campaign engine 350 may be part of the applications 142 or services 116 of the e-commerce platform 300 for example, or may be a standalone component of the e-commerce platform 300. The messaging campaign engine 350 in this example includes a campaign generator 354 sub-module. The campaign generator 354 may enable automatic generation of recommended parameters for a messaging campaign, as will be discussed further below. In some cases, the campaign generator 354 may generate one or more suggested notifications, for example. The messaging campaign engine 350 may communicate with the communication facility 129 or another communications interface of the e-commerce platform 300 to enable distribution of messages in accordance with a defined campaign. The messaging campaign engine 350 in this example may also store messaging campaign-related data, such as default campaign parameters 352, defined campaign parameters 356 and engagement metrics 358. The engagement metrics 358 may be provided to the messaging campaign engine 350 by the analytics facility 132. In some examples, some or all of the messaging campaign-related data, such as default campaign parameters 352, defined campaign parameters 356 and engagement metrics 358, may be stored outside of the messaging campaign engine 350, for example in the data facility 134.

A merchant or marketer may engage with the messaging campaign engine 350 to plan and implement a messaging campaign. For simplicity, the following discussion will refer to a merchant engaging with the messaging campaign engine 350; however it should be understood that the following discussion may be similarly applicable in the case of a non-merchant marketer instead of a merchant/marketer.

A merchant may generate a messaging campaign via the merchant device 102, using a user interface (e.g., an online portal) provided by the e-commerce platform 300. A messaging campaign may be generated by, for example, selecting from available campaign templates that may be populated using the default campaign parameters 352. A messaging campaign may be generated by only selecting a subset of the required campaign parameters (e.g., submitting only the message content), and the messaging campaign engine 350 may use default campaign parameters 352 to populate the remaining required campaign parameters.

In some examples, the merchant may not be required to select any campaign parameters at all. Instead, the e-commerce platform 300 may use information already available (via the e-commerce platform 300′s analytics facility 132 for example) about the merchant's online store 138 to automatically generate a proposed messaging campaign. For example, the messaging campaign engine 350 may automatically generate a proposed set of campaign parameters for a messaging campaign, based on information about the type of offering, number of sales, inventory size, etc., of the merchant's online store 138 on the e-commerce platform 300.

A messaging campaign, in the present disclosure, may be a planned notification or message (which may be a marketing message, in which case the messaging campaign may also be referred to as a marketing campaign) that is communicated to certain intended recipients. In some implementations, a messaging campaign (and in particular a marketing campaign) may be associated with an online store (e.g., the online store 138 of the e-commerce platform 300, or an online store that is not part of the e-commerce platform 300) and/or an online merchant.

The messaging campaign engine 350 may store default parameters 352, which may be predefined (e.g., by the e-commerce platform 300). The default parameters 352 are messaging campaign parameters that may be used to generate and carry out a messaging campaign when one or more required parameters have not been submitted by a merchant. In some examples, the default parameters 352 may be general to all merchants using the services of the messaging campaign engine 350. In some examples, there may be some level of specificity in the default parameters 352, for example there may be different sets of default parameters 352 depending on the size (e.g., as measured by the amount of yearly sales) of the merchant.

A merchant using the services of the messaging campaign engine 350 may also submit (e.g., via a user interface, such as an online portal provided by the e-commerce platform 300, which may be accessible via a merchant device 102 or marketer device 103) one or more user-submitted parameters for a messaging campaign. The user-submitted parameter(s) may be supplemented by one or more default parameters 352 as appropriate. In some examples, instead of submitting any user-submitted parameters, a merchant may select to use the default parameters 352.

The messaging campaign engine 350 uses the campaign generator 354 to generate a set of parameters for a messaging campaign. For example, the campaign generator 354 may determine that a set of user-submitted parameters should be supplemented by one or more default parameters 352 (e.g., the merchant has not submitted intended recipients, so the campaign generator 354 identifies a default intended demographic from the default parameters 352 and adds this as a parameter for the messaging campaign). The campaign generator 354 may generate recommended parameters for a messaging campaign, such as recommended distribution channel(s) for certain groups (or subgroups) of intended recipients. The campaign generator 354 may generate recommended parameters prior to the start of a messaging campaign, as well as dynamically during the life of the messaging campaign (e.g., generating new recommended parameters for different phases of a campaign). Any recommended parameter(s) generated by the campaign generator 354 may be notified to a merchant, who may be offered an option to accept or reject the recommended parameter(s).

After a set of campaign parameters have been generated and/or approved by the merchant (e.g., via the user interface provided by the e-commerce platform 100), including any recommended parameter(s) that have been offered for merchant approval, the approved parameters may be stored in the defined campaign parameters 356 of the messaging campaign engine 350. The messaging campaign engine 350 may store multiple sets of defined campaign parameters 356, corresponding to respective multiple messaging campaigns. The defined campaign parameters 356 stored by the messaging campaign engine 350 may be limited to active or ongoing messaging campaigns, or may also include historical or completed messaging campaigns.

The messaging campaign engine 350 uses the set of defined campaign parameters 356 to generate a notification with the defined message content(s), addressed to the defined intended recipient(s), to be sent over the defined distribution channel(s), and according to the defined schedule. In some examples, the messaging campaign engine 350 may make use of message templates (which may be stored as default parameters 352) to create message content(s). In some examples, the messaging campaign engine 350 may extract or otherwise obtain information (e.g., contact information for individual intended recipients) from the data facility 134 or other database in order to generate the messages. For example, the messaging campaign engine 350 may use customer information stored in the data facility 134 to identify individuals that belong in the group of intended recipients (e.g., a defined demographic, such as a defined age group) defined for a messaging campaign, and generate a notification to those individuals using contact information stored in the data facility 134. For privacy and security purposes, the messaging campaign engine 350 may limit the customer information extracted for a particular merchant campaign to information collected with consent (e.g., by the particular merchant and/or the platform 300) and not make such extracted information available to other merchants or third parties. The messaging campaign engine 350 may then provide the generated message to the communications facility 129, which in turn transmits the message to the intended recipients over the defined distribution channel.

The engagement analyzer 342 analyzes recipients' engagement with a messaging campaign. The engagement analyzer 342 may analyze engagement for a defined period of time (e.g., one month) after the sending of a notification. The engagement analyzer 342 may analyze recipients' engagement in an individualized manner and/or in a generalized (e.g., aggregated or statistical) manner. For example, if an individual recipient gives permission to access individualized information, the engagement analyzer 342 may analyze how that individual recipient responds (e.g., open or delete a message, click on a link in a message, etc.) to each phase of a given messaging campaign, i.e. whether a particular user action has been taken by the individual. Various suitable techniques may be used for individualized or generalized analysis of engagement.

Output generated by the engagement analyzer 342 may be stored by the messaging campaign engine 350 as engagement metrics 358. The engagement metrics 358 may be stored in association with information identifying the corresponding messaging campaign. In some examples, the engagement metrics 358 may be stored in association with information about certain parameters of the messaging campaign. Such detailed information may enable the messaging campaign engine 350 to determine (e.g., using a predictive algorithm or using a machine-learning system) which campaign parameters are more likely to result in positive engagement from intended recipients. For example, a response likelihood matrix or other statistics-based analytics may be generated to learn typical recipient responses, based on multiple historical campaigns.

In some examples, the engagement metrics 358 may be stored in association with information identifying an individual recipient or a generalized recipient group (e.g., demographic group). Engagement metrics 358 may be updated over the life of a messaging campaign (e.g., as recipients are messaged over multiple phases of the campaign). In some examples, engagement metrics 358 may be updated over multiple messaging campaigns (e.g., if a merchant conducts multiple messaging campaigns over time).

In one aspect, engagement metrics 358 and/or the engagement analyzer 342 determine or receive data regarding whether recipients have taken a particular user action. In this example, the platform 300 may have sent a notification and the engagement metrics 358 and/or the engagement analyzer 342 may identify or determine which recipients have taken the particular user action following receipt of the notification. The analysis may be over a window of time since transmission of the notification. The particular user action may include selecting a link, posting a social media post, downloading a file, purchasing a product, or some other action using the customer device 150. In some cases, detection of the particular user action may be performed by an external component and a message or report may be sent to the platform 300 indicating that the particular user action was detected in association with a specific user.

The messaging campaign engine 350 may then segment the users that were sent the notification into those users for which the particular user action was detected and those users for which it was not detected. Based on that segmentation, the groups of users may be analyzed to identify a correlated characteristic that may be predictive of membership in one of the groups. For example, the correlated characteristic may be a user characteristic that correlates to inclusion in the group of users that did not perform the particular user action and not in the group of users that performed the particular user action. In some cases, a correlated characteristic is a user characteristic that is correlated with inclusion in the group that did not perform the particular user action and is uncorrelated with inclusion in the group that did perform the particular user action.

User data for the users/recipients may be available to the engine 350 from the data repository 134, in some cases. In some cases, alternative or additional user data may be available to the engine 350 from an external data source, such as a third party platform, like a social media user database or the like, to which the platform 300 has access. In some cases, access to the third party data source may be based on a user consent obtained from the users during or subsequent to user registration with the platform 300.

The engine 350 may determine which user characteristic, if any, correlates most strongly to membership in the group that did not perform the user action versus the group that did perform the user action. The engine 350 may use one or more methodologies to measure or determine correlation so as to identify a user characteristic. For ease of reference, the group of users that performed the user action may be referred to as the reaction group and the group of users that did not perform the user action may be referred to as the non-reaction group. In a simple example, the engine 350 may identify a user characteristic shared by at least a minimum threshold number or percentage of the non-reaction group and that not found in association with users in the reaction group. In another example, the engine 350 may identify a user characteristic shared by at least a minimum threshold number or percentage of the non-reaction group and that is not found in association with more than a maximum threshold number or percentage of the reaction group, where the minimum threshold is higher than the maximum threshold.

In some other examples, the engine 350 may employ correlation measurement techniques to identify a user characteristic most strongly associated with membership in the non-reaction group. In one case, the correlation measurement may include determining a point-biserial correlation coefficient for each user characteristic and selecting the user characteristic having the correlation coefficient most strongly associated with membership in the non-reaction group. In some cases another correlation measurement technique may be used to determine correlation coefficients for each candidate user characteristic. In some cases, the engine 350 identifies a user characteristic as predictive of membership in the non-reaction group, even if it is the strongest coefficient of the candidates, only if the corresponding correlation coefficient is greater than a minimum relevancy value.

In one case, the identified user characteristic may be saved within the platform 300 within the defined campaign parameters 356 or elsewhere, as indicative of non-responsiveness to a particular notification class or type. The identified user characteristic may be used as basis for future segmentation of users/customers to identify a subgroup having that user characteristic so as to either exclude those users/customers from a primary group to which a notification is to be sent, and/or to place those users/customers in a secondary group to which a different notification is to be sent.

In some implementations, the identified user characteristic may be used by the engine 350 and, in some cases, the campaign generator 354, to generate a notification targeting users having the identified user characteristic. That is, the user characteristic may be used partly as the basis for generating a proposed notification or its content.

Identification of the user characteristic associated with the non-reaction group may improve the operation of future notification campaigns. For example, it may permit the platform 300 to avoid sending notifications to users that are predictively unlikely to react based on those users having the identified user characteristic, which saves in wasted notifications and bandwidth. In another example, the user characteristic permits the platform 300 to target those users having the user characteristic with a different notification that may be more likely to garner a user reaction without first wasting resources on sending the primary notification, thus shortcutting the process of sending a relevant notification targeted to the group of users. Moreover, the identified user characteristic may be used to generate suggested new notification content for a future phase of a campaign. This permits a campaign to evolve to micro-target groups of users based on user characteristics identified from analyzing actions/non-actions in response to an earlier campaign or to an earlier phase of a current campaign. Notably, the described process and system avoids the need to walk an individual user through all phases of campaign notification in order to learn that user's response behaviour so as to target notifications to characteristics learned for that user from that user's interactions. Through leveraging analysis of response metrics and user characteristic correlations the present application describes systems and methods that ensure later users/recipients are “fast-tracked” to more effective notifications without needing to send them earlier less effective ones, thereby saving on bandwidth and other computing resources.

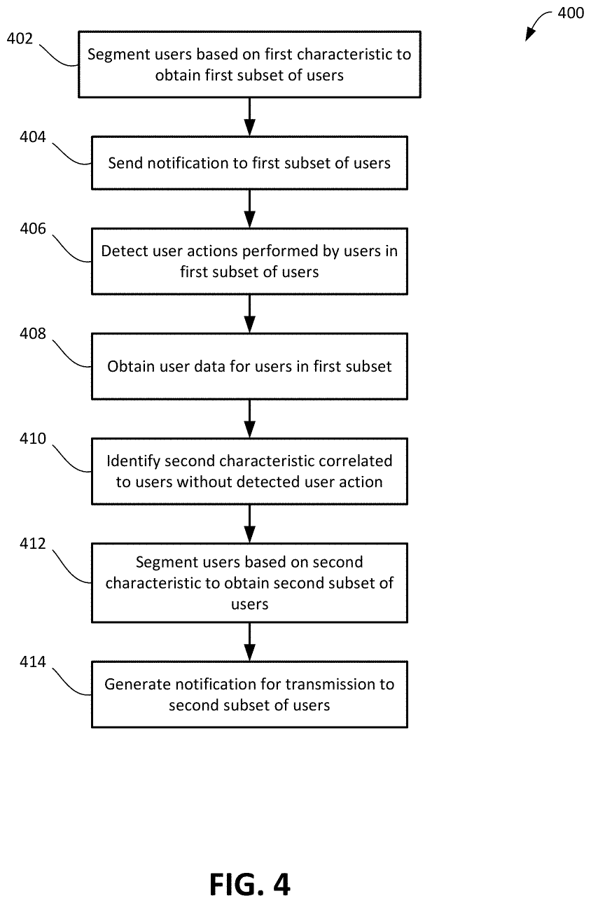

Reference is now made to FIG. 4, which shows in flowchart form one example method 400 for generating notification from a computing system. In this example the computing system may be an e-commerce platform configured to send notifications to a plurality of users. The system may store user data for each of the users. In this example, the user data includes a plurality of user characteristics. Example user characteristics may include user demographics, such as age, sex, income, geographic location, language, etc. Other example user characteristics may include purchase history, such as product purchased, time and date of purchase, merchant, payment details, purchase channel (e.g., online, instore, mobile app, etc.), product characteristics (e.g., class or category of product, size, weight, colour, or other attributes), etc. Other example user characteristics may include browsing history, such as browsing history on the platform or on a specific merchant store, cart abandonment history, such as items selected but not purchased, duration of time spent on specific merchant sites, time since last browsing session, etc.

In operation 402, the system optionally segments its plurality of users based on a first characteristic to obtain a first subset of users. The first characteristic may be selected on the basis that a campaign or a notification is to be targeted to users having the first characteristic. For example, the first characteristic may be a geographic location (e.g. United States, or California, etc.) or a previous purchase from a specific merchant. In some cases, the first characteristic may be multiple characteristics (e.g., a conjunction or disjunction of characteristics), such as users located in the United Kingdom that purchased a certain class of product from a particular retailer in the past 12 months.

Once the first subset of users is obtained, in this example the system then sends a notification to the first subset of users in operation 404. The notification may be a message, such as an email, mobile app message, text message, instant message, social media direct message, etc. The notification may be directed to a mobile app or other such software component associated with the user that causes the mobile app or other software component to generate a message, such as a pop-up or other type of notification when the user next accesses the mobile app. The notification may be any other type of electronic communication that is directed to the specific users in the first subset of users that results in some action or event. The action or event may include communicating information or an offer or other advertising or solicitation information, such as coupon or discount code or other promotional information. The action or event may include a poll or survey or the like. The action or event may include accessing or displaying or otherwise outputting third party data, e.g. linking to an online multimedia event or video or other third party media.

In operation 406, the system detects user actions in connection with the notification. The detected user action may be a prescribed user action associated with the notification. For example, the notification itself may contain an actionable item, such as a selectable link. The link may appear as a text hyperlink, a graphic advertisement, an actionable “button”, or the like. The notification itself may have an auto-report feature where the customer device is configured to notify the platform if the user opens the notification or performs some prescribed action in connection with the notification. The prescriber user action may be disconnected from the notification itself, such as the user purchasing a specific product or purchasing from a specific merchant via the platform. Other examples may include participating in a poll by selecting one of the options, browsing to a certain website using the customer device, posting a post relating to a certain topic or product on a social media feed, liking, sharing, or reposting a certain social media post, or other such user actions.

In some cases, the prescribed user action is one that is detectable by the platform itself, for example because it is an action performed on the platform or it is an action within or connected to the notification that results in a notification back to the platform. In some cases, the prescribed user action is one that is detectable outside the platform, for example by a third party media monitoring service, by a social media service, by an ISP, or by some other third party entity, and the platform is configured to receive a report or notification regarding such a detected action.

Irrespective of the type or category of user action, the system determines, in operation 406, whether the prescribed user action is detected with regard to each of the users that was sent the notification, i.e. the users in the first subgroup. This determination may occur over a time window from sending of the notification or occurrence of the associated event or action. The time window may be configurable by an administrator of the platform or a merchant or marketer in some cases. Example time windows may be short for fleeting notifications (e.g. social media type notifications that appear in a stream or feed) and may be on the order of minutes or hours, or may be long for more persistent notifications (e.g. email, instant message, text messages, mobile app notifications, etc.) and may be on the order of multiple days, weeks, or even over a month.

In some instances, no primary notification is sent and the method 400 begins with operation 406, and the detection of user reactions or non-reactions in connection with an event or action. Such an event or action may not be connected to a notification from the system and may not be an event or action initiated by the system. For example, the event or action may be a third party media release or event, e.g. release of a new television program, screening of a new movie, announcement of an upcoming concert event, occurrence of a news event, or the like.

In operation 408, the system obtains user data for the users in the first subgroup. As noted above, the user data may be data stored on the platform. It may also or alternatively be data stored outside the platform and available from third party sources. The user data includes user characteristics. Example user characteristics may include user demographics, such as age, sex, income, geographic location, language, etc. Other example user characteristics may include purchase history, such as product purchased, time and date of purchase, merchant, payment details, purchase channel (e.g., online, instore, mobile app, etc.), product characteristics (e.g., class or category of product, size, weight, colour, or other attributes), etc. Other example user characteristics may include browsing history, such as browsing history on the platform or on a specific merchant store, cart abandonment history, such as items selected but not purchased, duration of time spent on specific merchant sites, time since last browsing session, etc.

The system may further group the users into a reaction group containing those users from the first subset for which the prescribed user action was detected in operation 406 and a non-reaction group containing those users from the first subset for which the prescribed user action was not detected in operation 406.

The system analyzes the user data for the users in the reaction group and the non-reaction group and identifies a second characteristic correlated to membership in the non-reaction group, as indicated by operation 410. The second characteristic may be referred to as a “correlated characteristic”. As noted above, various correlation measurements may be used. A correlation coefficient may be determined for each candidate user characteristic. The system may select the candidate user characteristic having the strongest correlation coefficient. Selection of the user characteristic may be subject to its associated coefficient being higher than a minimum relevancy value.

Once a second characteristic is identified in association with the non-reaction group it may be stored by the system. At some later time, when the system is triggered to generate a notification to a set of users, the system may segment users based on the second characteristic, as indicated by operation 412. The segmentation may be segmentation of the plurality of users on the platform to identify those users having the second characteristic.

The segmentation in operation 412 may be segmentation of a first subset generated in a manner similar to the manner described in connection with operation 402, where the plurality of users is first segmented based on one or more first characteristics to select out a first subset of users to which a primary notification may be directed. The second characteristic is then used as the basis for further segmenting the first subset to extract a second subset containing those users from the first subset that have the second characteristic. The users of the second subset may not be sent the primary notification.

In some cases, the users of the second subset may be sent an alternative notification, such as is indicated by operation 414. In operation 414, a notification to the second subset is generated. The notification may be based on the second characteristic in some cases. That is, the second characteristic may be partly used to select the content of the notification.

It will be understood that the set of users to which segmentation is applied in operation 412 may be a different set of users than were segmented in operation 402. In some cases, they may be an entirely different set of users because the first characteristic(s) for generating the first subset may be different. In other cases, they may be an updated version of the first subset, where some new users may have been added and some old users may no longer be included. In other words, at least some of the users in the second subset may not have received the primary notification in operation 404.

By way of illustrative non-limiting example, the primary notification may be a product offering or advertisement with a selectable link that resolves to the merchant's online store offering relating to that product. The primary notification may be targeted to a first subset of users, such as those users in a geographic area that are previous customers of the merchant. The system may monitor for response to the primary notification where the prescribed user action is selection of the selectable link resulting in that user accessing the merchant's online store offering. In some other examples, the prescribed user action may be purchase of the product offered through the platform. After the time window, the first subset is grouped into those that reacted and those that did not. The system then analyzes user data, i.e. user characteristics, for the users in the first subset to identify whether there is a user characteristic sufficiently strongly correlated to the non-reaction group. In this example, the system may identify that users in the non-reaction group were likely to have not visited the merchant site within the past three months, whereas users in the reaction group were likely to have visited the merchant site within the past three months. As another example, the system may identify that users in the non-reaction group were likely to be under 35 years old. As another example, the system may identify that users in the non-reaction group tended to have purchased a particular product, perhaps a related or competing product.

At a later time, the platform may send a new notification regarding a new product offering for the same merchant or a new merchant. The platform may segment the then-current plurality of users on the basis of one or more first characteristics to obtain a new first subset. The first characteristics may be the same first characteristics used previously to generate the previous first subset or may be different. The platform further segments the new first subset to identify and extract those users in the new first subset that have the identified correlated user characteristic, e.g. those users under 35 years old. The platform may then send the primary notification to the remaining users in the modified new first subset and may send an alternative notification to the second subset. The alternative notification may be generated based on the specific user characteristic. In some cases, the generation may be based on predefined business logic rules. In some cases, the generation may be based on machine learning algorithms for example that identify notification features or content or channels that are more likely to generate a reaction in association with the identified user characteristic. In this example, the alternative notification may be to use a different notification channel for the user's under 35, e.g. social media direct message instead of email, or may be to use different content, e.g. a different product item more likely to appeal to a user under 35.

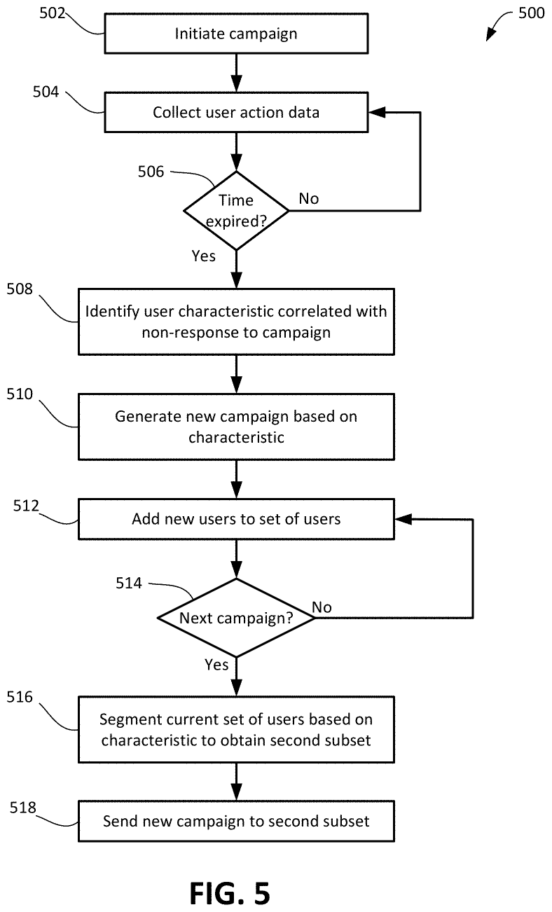

Reference is now made to FIG. 5, which shows another example method 500 of generating notifications from a computing system. As above, the computing system in this example may be an e-commerce platform and, in particular, an e-commerce platform configured to launch and manage messaging campaigns for merchants. In operation 502 the platform initiates a campaign. The campaign may include sending a notification to a first subset of users in some cases. Operation 502 may or may not include a segmentation operation to obtain the first subset of users based on one or more first characteristics. In some cases, the campaign may involve notifications or events outside the control of the e-commerce platform such that operation 502 is limited to receiving a notification that the campaign is launched.

In operation 504, the system detects a particular user action associated with individual users in the first subset of users. As noted above, the particular user action may be directly detected by the system or may be indirectly detected by the system through receiving notification regarding the particular user action from an external system.

In operation 506 the system determines whether the time window set for monitoring for the particular user action has closed. If not, then it continues to detect particular user actions in operation 504. If it has closed, then in operation 508 the system identifies a user characteristic correlated to inclusion in the non-reactive group of users, i.e. those users in the first subset for whom the particular user action was not detected in operation 504. As noted above, various correlation measurements may be used. A correlation coefficient may be determined for each candidate user characteristic. The system may select the candidate user characteristic having the strongest correlation coefficient. Selection of the user characteristic may be subject to its associated coefficient being higher than a minimum relevancy value.

Once the correlated user characteristic has been identified, then the system may generate a new campaign based on the correlated user characteristic in operation 510. The new campaign may be specifically targeted at the non-reactive class of users. That is, the new campaign may be generated based on the correlated user characteristic, which may be one or more factors in selecting the campaign content and/or channel. As example, the user characteristic may relate to geographical location, in which case the campaign may use a channel or content (e.g. discount, product offering, coupon style, etc.) that is associated with that geographical location. The system may have historical data regarding product purchases and/or discount/coupon usage that is stored in association with frequency of use or purchase data that provides correlation information indicating which products, discounts, or other campaign details are most strongly correlated to particular user characteristics, such as age, purchase history, browsing history, geography, etc. That correlation data may be the basis for generating the new campaign based on the identified user characteristic.

The system may then continue to add (or remove or amend) the set of users known to the system as indicated by operation 512. This may occur as various merchants attract new customers, for example, and new user profiles are created, or existing user profiles are modified or updated or deleted. Meanwhile the system awaits an indication that a next campaign is to begin, as indicated by operation 514. The indication may be receipt of an instruction input from an administrator device or a merchant device in some cases. The indication may be expiry of a preset time since the previous campaign in some cases. The indication may be occurrence of a certain preconfigured date (e.g. a set number of days prior to a calendar event, such as Black Friday or holidays or other dates of significance).

Once the system determines that a new campaign is to be initiated in operation 514, then in operation 516 the system segments the now-current set of users based, at least in part, on the identified user characteristic to obtain a second subset of users. The second subset of users may include users that received a first notification in the initial campaign and includes at least some users that did not receive a first notification in the initial campaign. In operation 518 the system sends a campaign notification for the new campaign to the second subset of users.

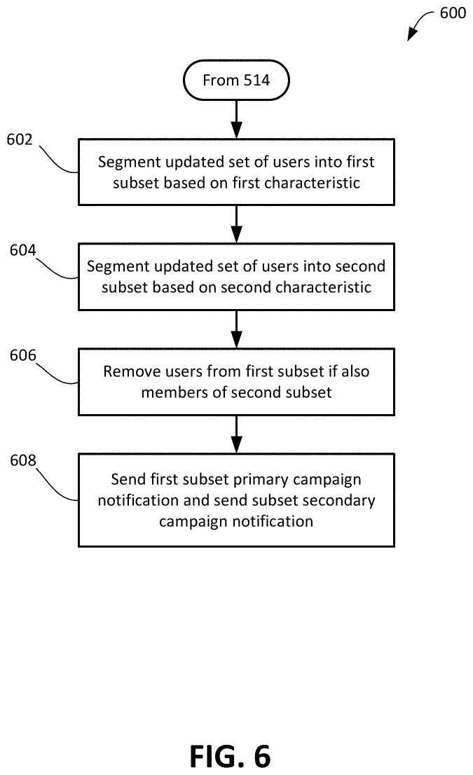

Reference will now be made to FIG. 6, which shows another method 600 of generating a notification for a campaign from a computer system. FIG. 6 may feature the same initial campaign operations described above in connection with FIG. 5, namely, operations 502-514, in which user reactions to an event or notification are detected and users are segmented on the basis of whether a particular user action was detected, and the system identifies a correlated user characteristic correlated to the non-reactive group of users for which the particular user action was not detected. In this example, the initial campaign is based on a first segmenting of the users of the system into a first subset based on a first characteristic and the sending of a first notification to the first subset of users. FIG. 6 follows from operation 514, after the system determines that a new campaign is to be initiated.

In operation 602, the system segments an updated set of users into a first subgroup based on a first characteristic. The first characteristic may be the same one or more user characteristics designated in association with the initial campaign. Then in operation 604 the system segments the first subgroup on the basis of the identified correlated user characteristic. That is, it identifies those users in the first subgroup that have both the first characteristic and the correlated user characteristic. It then extracts those users from the first subgroup to form a second subgroup in operation 606. In operation 608 the system sends the users in the modified first subgroup a primary campaign notification and sends the users in the second subgroup an alternative campaign notification. The primary campaign notification may be the same notification sent in the initial campaign in some cases. In some cases, the primary campaign notification is similar to the notification sent in the initial campaign in terms of its characteristics, such as the channel used, the format, the nature of the content, while differing in terms of the specific product, event or item that the campaign relates to. The alternative campaign notification may differ from the primary campaign in one or more ways. For example, the alternative campaign notification may employ a different channel, format, etc., but relate to the same specific product, event or item. In another example, the alternative campaign notification may use the same channel, format, etc., but may relate to a different product, event or item.

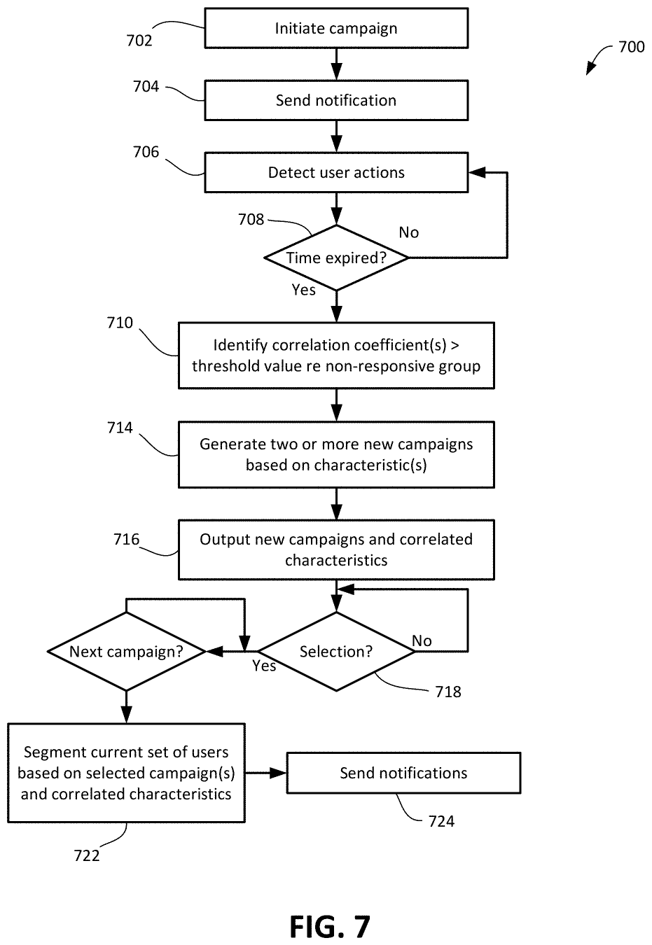

Reference will now be made to FIG. 7, which shows yet a further example method 700 of generating notifications from a computer system. In this example the computing system may be an e-commerce platform configured to send notifications to a plurality of users. The system may store user data for each of the users. In this example, the user data includes a plurality of user characteristics. Example user characteristics may include user demographics, such as age, sex, income, geographic location, language, etc. Other example user characteristics may include purchase history, such as product purchased, time and date of purchase, merchant, payment details, purchase channel (e.g., online, instore, mobile app, etc.), product characteristics (e.g., class or category of product, size, weight, colour, or other attributes), etc. Other example user characteristics may include browsing history, such as browsing history on the platform or on a specific merchant store, cart abandonment history, such as items selected but not purchased, duration of time spent on specific merchant sites, time since last browsing session, etc.

In this example, the method 700 includes, in operation 702, segmenting the set of users to select a first subset based on at least a first characteristic. As noted above, the first characteristic may be a user characteristic or a combination of two or more user characteristics. The system then sends a notification to the users in the first subset in operation 704 and identifies whether those users perform a particular user action in operation 706. The users from the first subset that are detected or identified as having performed the particular user action may be allocated into a reaction group and the users from the first subset that are not detected or identified as having performed the particular user action are grouped into a non-reaction group.

Once the monitoring time window ends, in operation 708, the system then identifies one or more correlated characteristics in operation 710. That is, the system determines whether there is a user characteristic that correlates to belonging to the non-reactive group of users. As noted above, various correlation measurement techniques may be used to determine correlation coefficients associated with respective ones of the user characteristics in order to determine how strongly correlated the characteristic is with belonging to the non-reaction group. In this example, operation 710 may include determining whether a particular correlation coefficient is greater than a threshold value, where the threshold value may be set or selected to tune the system. The threshold value may represent a desired strength of correlation or selectivity. In this example, operation 710 may include identifying two or more correlated characteristics that have associated coefficients above the threshold value. That is, the identification of correlated characteristics may include identifying two or more correlated characteristics.

In operation 714 the system then generates two or more new campaigns. The two or more new campaigns may specify a communication channel, a product offering, a service offering, a discount type or amount, a loyalty incentive, or some other content relating to the campaign. Some aspects of the campaigns may be based on selected or set default parameters, which may be pre-configurable by an administrator of the system or by a particular merchant or marketer.

The two or more campaigns are generated based on the correlated characteristic(s) identified in operation 710. In some cases, multiple correlated characteristics are used jointly to generate each of the two or more campaigns. In some cases, each campaign is based on a respective one of the correlated characteristic(s).

The system outputs the two or more campaigns in operation 716. Output of the two or more campaigns may include displaying details of the two or more campaigns on a merchant or marketer device. It may include sending a message or other communication to a merchant or marketer account providing details regarding the two or more campaigns. In some cases, it may include transmitting information regarding the two or more campaigns to a mobile app or other associated software on a merchant or marketer device. The merchant or marketer device may display details regarding the two or more campaigns and may, in some cases, specify the correlated coefficient(s) that served as the basis for generating the campaign.

In operation 718 the system may receive selection or authorization of one or more of the campaigns. If the campaigns are alternative campaigns directed as the same segmentation of users based on the same characteristics or combination of characteristics, then the system may require selection of a preferred one of the campaigns. If the campaigns are suggested campaigns targeting respective segments of users based on different correlated characteristics then the system may permit selection of two or more campaigns.

Once a trigger event is detected for a next campaign in operation 720, then the system proceeds to initiate the next campaign in operation 722. The trigger event may include an instruction from a marketer or merchant device in some cases. The trigger event may be time-based in some cases, e.g. expiry of a time since the last campaign, or detection of a date scheduled for the next campaign, or the like.

In operation 722, the system segments the then-current set of users, which may be different from the set of users segmented in operation 702, into two or more subsets. The segmentation is based, at least in part, on one or more of the correlated characteristics identified in operation 710. In particular, segmentation is at least partly based on the correlated characteristics that were the basis for one of the campaigns generated in operation 714 and selected or authorized in operation 718. The system then sends one or more respective notifications to the segmented subsets of users containing respective campaign content in operation 724 in accordance with the campaign parameters.

It will be understood that some of the operations of the example methods may be performed in a different order or simultaneously without materially impacting operation of the methods.

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g. Long Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A method for generating notifications from a computing system, the method comprising:
selecting, based on a first characteristic and stored data associated with each user, a first subset of users from a set of users;
transmitting a primary notification to the first subset of users;
detecting whether the primary notification produced a particular user action for the users of the first subset of users and segmenting the first subset into a first group of users associated with the particular user action and a second group of users not associated with the particular user action;
identifying, using the stored data associated with each user in the second group of users not associated with the particular user action, a second characteristic different from the first characteristic and correlated to the second group of users;
identifying a third group of users having the second characteristic; and
generating a secondary notification for transmission to the third group of users.

2. The method claimed in claim 1, wherein the secondary notification generated is an alternative notification different from the primary notification.

3. The method claimed in claim 1, further comprising subsequently adding a new user to the set of users, the new user having the second characteristic, and transmitting the secondary notification to the new user instead of the primary notification when transmitting the primary notification to a further subset of the set of users.

4. The method claimed in claim 1, further comprising, subsequently:
selecting a second subset of users from a then-current set of users based on the first characteristic;
identifying a subgroup of users in the second subset that have the second characteristic;
transmitting a second primary notification to the second subset of users excluding the subgroup of users; and
transmitting the secondary notification to the subgroup of users.

5. The method claimed in claim 1, further comprising generating two or more notifications based on the second characteristic, sending data regarding the two or more notifications to a merchant account, receiving a selection response indicating one of the two or more notifications, and transmitting the selected notification as the secondary notification to the third group of users.

6. The method claimed in claim 1, wherein identifying includes determining that the second characteristic is uncorrelated with the first group of users.

7. The method claimed in claim 6, wherein identifying includes calculating a correlation coefficient.

8. The method claimed in claim 1, wherein the secondary notification has at least one of different content from the primary notification or a different communication channel from the primary notification.

9. The method claimed in claim 1, wherein the computing system includes an ecommerce platform and the data regarding each user includes at least product purchase data relating to a merchant, and wherein the primary notification and the secondary notification each contain product information regarding one or more products available from the merchant.

10. The method claimed in claim 9, wherein the second characteristic relates to product purchase history with respect to the merchant.

11. The method claimed in claim 10, wherein the second characteristic is one of time of last product purchase, last product purchased, number of products purchased, frequency of discounted products purchased, or frequency of new products purchased.

12. A computing system to generate notifications, the system comprising:
one or more processors;
memory storing data associated with each user in a set of users; and
a processor-readable storage medium containing processor-executable instruction that, when executed by the one or more processors, are to cause the one or more processors to:
select, based on a first characteristic and the stored data associated with each user, a first subset of users from the set of users;
transmit a primary notification to the first subset of users;
detect whether the primary notification produced a particular user action for the users of the first subset of users and segment the first subset into a first group of users associated with the particular user action and a second group of users not associated with the particular user action;
identify, using the stored data associated with each user in the second group of users not associated with the particular user action, a second characteristic different from the first characteristic and correlated to the second group of users;
identify a third group of users having the second characteristic; and
generate a secondary notification for transmission to the third group of users.

13. The computing system of claim 12, wherein the secondary notification generated is an alternative notification different from the primary notification.

14. The computing system claimed in claim 12, wherein the instructions, when executed, are to further cause the one or more processors to subsequently add a new user to the set of users, the new user having the second characteristic, and transmit the secondary notification to the new user instead of the primary notification when transmitting the primary notification to a further subset of the set of users.

15. The computing system claimed in claim 12, wherein the instructions, when executed, are to further cause the one or more processors to:
select a second subset of users from a then-current set of users based on the first characteristic;
identify a subgroup of users in the second subset that have the second characteristic;
transmit a second primary notification to the second subset of users excluding the subgroup of users; and
transmit the secondary notification to the subgroup of users.

16. The computing system claimed in claim 12, wherein the instructions, when executed, are to further cause the one or more processors to generate two or more notifications based on the second characteristic, send data regarding the two or more notification to a merchant account, receive a selection response indicating one of the two or more notifications, and transmit the selected notification as the secondary notification to the third group of users.

17. The computing system claimed in claim 12, wherein the instructions, when executed, are to cause the one or more processors to identify by determining that the second characteristic is uncorrelated with the first group of users.

18. The computing system claimed in claim 17, wherein the instructions, when executed, are to cause the one or more processors to identify by calculating a correlation coefficient.

19. The computing system claimed in claim 12, wherein the secondary notification has at least one of different content from the primary notification or a different communication channel from the primary notification.

20. The computing system claimed in claim 12, wherein the computing system includes an e-commerce platform and the data regarding each user includes at least product purchase data relating to a merchant, and wherein the primary notification and the secondary notification each contain product information regarding one or more products available from the merchant.

21. The computing system claimed in claim 20, wherein the second characteristic relates to product purchase history with respect to the merchant.

22. The computing system claimed in claim 21, wherein the second characteristic is one of time of last product purchase, last product purchased, number of products purchased, frequency of discounted products purchased, or frequency of new products purchased.

23. A non-transitory computer-readable medium storing processor-executable instructions for generating notifications from a computing system, wherein the instructions, when executed by one or more processors, are to cause the one or more processors to:
select, based on a first characteristic and stored data associated with each user, a first subset of users from a set of users;
transmit a primary notification to the first subset of users;
detect whether the primary notification produced a particular user action for the users of the first subset of users and segment the first subset into a first group of users associated with the particular user action and a second group of users not associated with the particular user action;
identify, using the stored data associated with each user in the second group of users not associated with the particular user action, a second characteristic different from the first characteristic and correlated to the second group of users;
identify a third group of users having the second characteristic; and
generate a secondary notification for transmission to the third group of users.
